(19) United States
(12) Patent Application Publication
(10) Pub. No.: US 2026/0110374 A1
(43) Pub. Date: Apr. 23, 2026

(54) J-HOOK FOR SUPPORTING A PIPE

(71) Applicant: Joe Mills, Fowlerville, MI (US)

(72) Inventor: Joe Mills, Fowlerville, MI (US)

(21) Appl. No.: 18/923,992

(22) Filed: Oct. 23, 2024

(51) Int. Cl. F16L 3/123; F16L 3/12

(52) U.S. Cl. CPC F16L 3/123; F16L 3/1218

(57) ABSTRACT

A J-hook for supporting a pipe includes a rod and a hook. The rod has a first end and a second end. The rod includes eight side surfaces such that the rod has an octagonal cross-sectional shape. The rod includes a plurality of apertures in the side surfaces. The apertures are arranged in aligned pairs of opposing apertures to permit insertion of a securing element through a selectable one of the aligned pairs of opposing apertures, such that the securing element extends through the rod perpendicular to an axis of the rod and into a building structure on which a pipe is to be mounted. The hook is positioned at the second end of the rod. The hook is U-shaped and defines a receptacle space designed to receive a portion of the pipe therein in a contoured fit.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to J-hooks and more particularly pertains to a new J-hook for supporting a pipe on a wall or other building structure. In plumbing and related industries, pipes are often hung on walls and other building structures using support pieces, such as hooks and clips. J-hooks are a common type of support. However, current J-hook designs cause the installation to be very limited to flat walls with the hook portion projecting perpendicular to the wall and with the pipe lying flat and parallel to the wall. The new J-hook permits installation on different surfaces with the hook portion oriented perpendicularly or at an angle to the surface of most any structure to provide different support configurations.

### (2) Description of Related Art Including Information Disclosed Under 37 CFR 1.97 and 1.98

The prior art relates to J-hooks. The prior art, as best understood, does not disclose a J-hook that includes a rod and a hook, wherein the rod has eight side surfaces such that the rod has an octagonal cross-sectional shape that permits the rod to be oriented on a surface at different angles. The rod has apertures therein to allow affixing at the different angles with a nail or screw.

### BRIEF SUMMARY OF THE INVENTION

An embodiment of the disclosure meets the needs presented above in a J-hook generally comprising a rod and a hook. The rod has a first end and a second end. The rod includes eight side surfaces such that the rod has an octagonal cross-sectional shape. The rod includes a plurality of apertures in the side surfaces. The apertures are arranged in aligned pairs of opposing apertures to permit insertion of a securing element through a selectable one of the aligned pairs of opposing apertures, such that the securing element extends through the rod perpendicular to an axis of the rod and into a building structure on which a pipe is to be mounted. The hook is positioned at the second end of the rod. The hook is U-shaped and defines a receptacle space designed to receive a portion of the pipe therein in a contoured fit.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a J-hook according to an embodiment of the disclosure.

FIG. 2 is a close-up view of a portion of an embodiment of the disclosure.

FIG. 3 is a side view of an embodiment of the disclosure.

FIG. 4 is a side exploded view of an embodiment of the disclosure.

FIG. 5 is a front view of an embodiment of the disclosure.

FIG. 6 is a back view of an embodiment of the disclosure.

FIG. 7 is a top view of an embodiment of the disclosure.

FIG. 8 is a side view of an embodiment of the disclosure in use.

FIG. 9 is an end view of an embodiment of the disclosure in use.

### DETAILED DESCRIPTION OF THE INVENTION

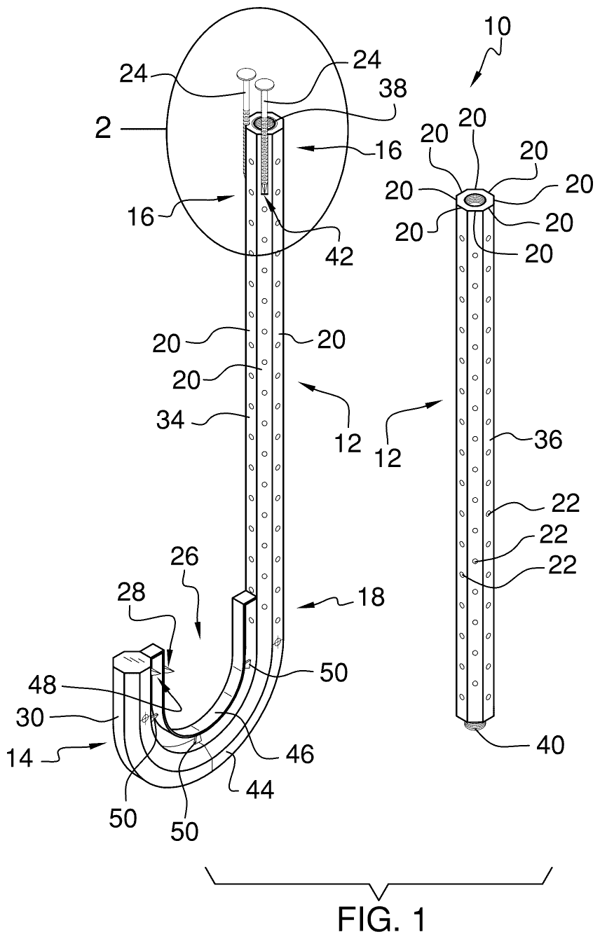

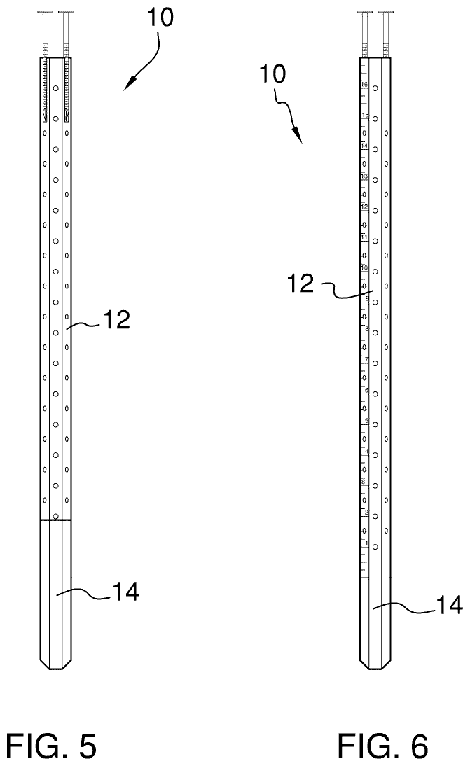

With reference now to the drawings, and in particular to FIGS. 1 through 9 thereof, a new J-hook embodying the principles and concepts of an embodiment of the disclosure and generally designated by the reference numeral 10 will be described.

As best illustrated in FIGS. 1 through 9, the J-hook 10 generally a rod 12 and a hook 14. The rod 12 has a first end 16 and a second end 18. The rod 12 includes eight side surfaces 20 such that the rod 12 has an octagonal cross-sectional shape. The rod 12 includes a plurality of apertures 22 in the side surfaces 20. The apertures 22 are arranged in aligned pairs of opposing apertures 22 to permit insertion of a securing element 24 through a selectable one of the aligned pairs of opposing apertures 22, such that the securing element 24 extends through the rod 12 perpendicular to an axis of the rod 12 and into a building structure on which a pipe 60 is to be mounted. The hook 14 is positioned at the second end 18 of the rod 12. The hook 14 is U-shaped and defines a receptacle space 26 designed to receive a portion of the pipe 60 therein in a contoured fit.

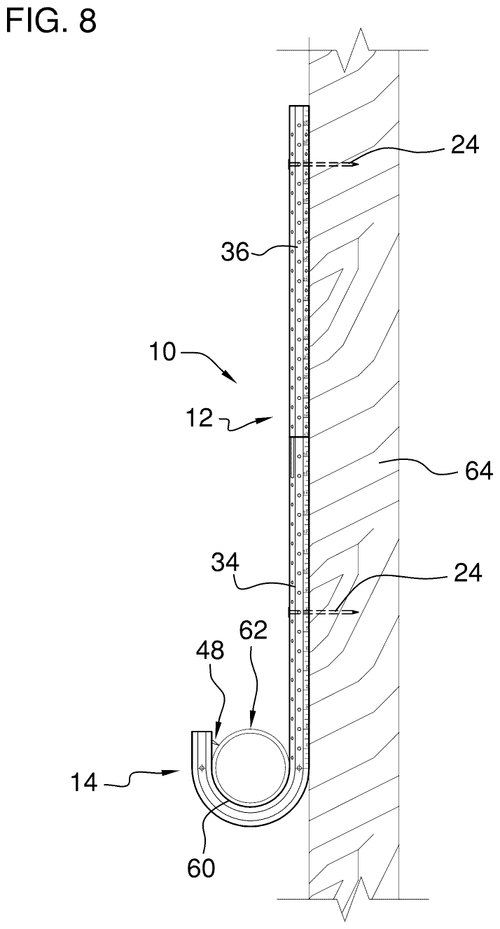

As shown in FIG. 1, the J-hook 10 further includes an elongated projection 28 positioned to project inwardly from a surface of the hook 14 into the receptacle space 26. In the exemplary embodiment, the elongated projection 28 is positioned at an upper portion 30 of the hook 14. The elongated projection 28 is designed to project partially above an exposed upper surface 62 of the portion of the pipe 60 in the hook 14 and be in contact with the exposed upper surface 62 to block upward movement of the pipe 60 out of the hook 14, as best seen in FIG. 8. The elongated projection 28 includes resilient material to permit temporary deformation of the elongated projection 28 out of an initial position during insertion of the portion of the pipe 60 into the hook 14 and return to the initial position in a snap-fit manner. The elongated projection 28 is essentially in the form of a barb angled downwardly into the receptacle and includes a pointed tip 32.

In the exemplary embodiment shown in FIG. 1, the rod 12 includes a main rod section 34 integrally formed with the hook 14 and an extension rod section 36 connected to the main rod section 34. The extension rod section 36 is detachable from the main rod section 34 to permit shortening of the rod 12. This design allows the user to customize the length of the rod 12 in accordance with installation requirements. The main rod section 34 includes a female threaded receptacle 38 and the extension rod 12 includes a male threaded projection 40 designed to be screwed into the female threaded receptacle 38, though other connections, such as snap-fit tabs or clasps, would be within the scope of the disclosure. In one possible embodiment, the extension rod section 36 could be omitted and the rod 12 could be a single integral unit. In another possible embodiment, there could be two or more extension rods 12 to provide even greater customization of the length of the rod 12.

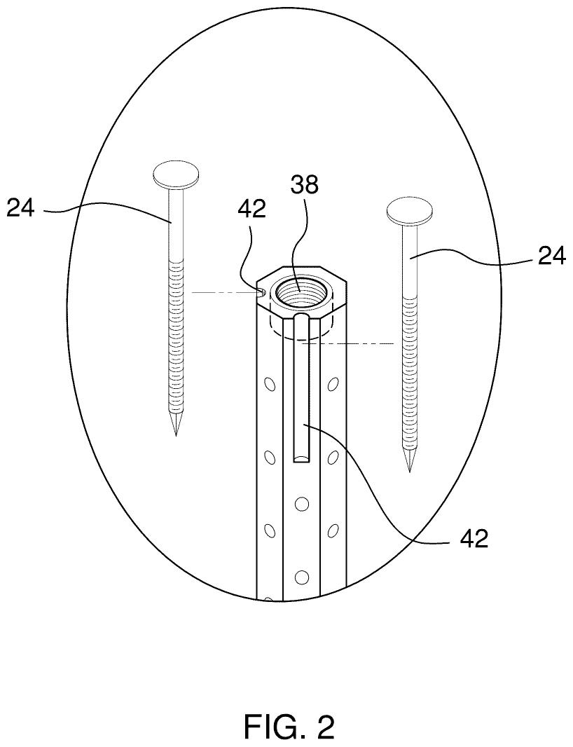

As shown in the exemplary embodiment in FIGS. 1 and 2, the J-hook 10 further includes two slots 42 that are positioned in the side surfaces 20 and extend parallel to the axis of the rod 12. Each of the slots 42 is designed to receive and store the securing element 24, such as a nail as shown in FIG. 2. In this manner the worker always has nails available to secure the J-hook 10 to a building structure, such as a wall or section of lumber. While the two slots 42 are shown in the main rod section 34 in FIG. 1, the two slots 42 could alternatively be located in the extension rod section 36. In another possible embodiment, the two slots 42 could be omitted from the rod 12.

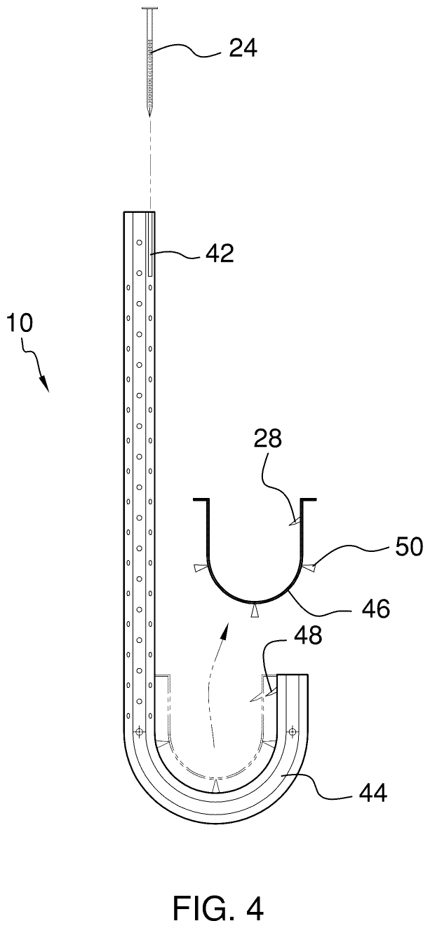

In the exemplary embodiment shown in FIG. 1, the hook 14 includes a main hook section 44 integrally formed with the rod 12 and a detachable hook section 46 detachably connected to the main hook section 44. The detachable hook section 46 has a smaller width and depth than the main hook section 44 to permit the hook 14 to receive pipes 60 of different diameters. The detachable hook section 46 includes the elongated projection 28, and the main hook section 44 includes an additional elongated projection 48. In the exemplary embodiment, the detachable hook section 46 is connected to the main hook section 44 by break-off tabs 50. If the user wishes to support a pipe 60 that is larger than the space in the detachable hook section 46, the user can break off the detachable hook section 46, as shown in FIG. 4, and utilize the main hook section 44, which has the additional elongated projection 48 to hold the pipe 60. In one possible embodiment, the detachable hook section 46 could be omitted and the J-hook 10 would only be suitable for one size of pipe 60.

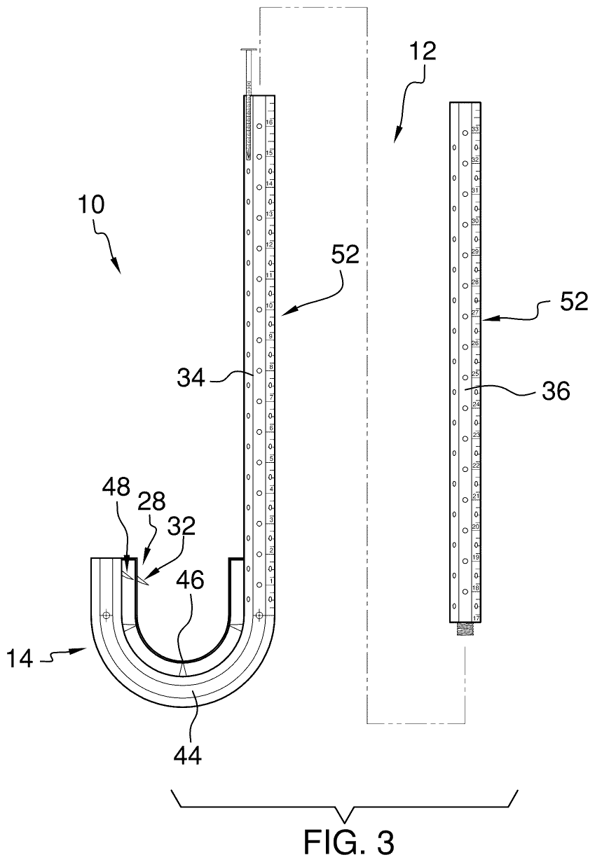

In the exemplary embodiment in FIG. 3, the rod 12 includes measurement markings 52 on one of the side surfaces 20. These measurement markings 52 would allow the user to have a built-in measurement tool rather than needing to carry a separate measuring tape or stick.

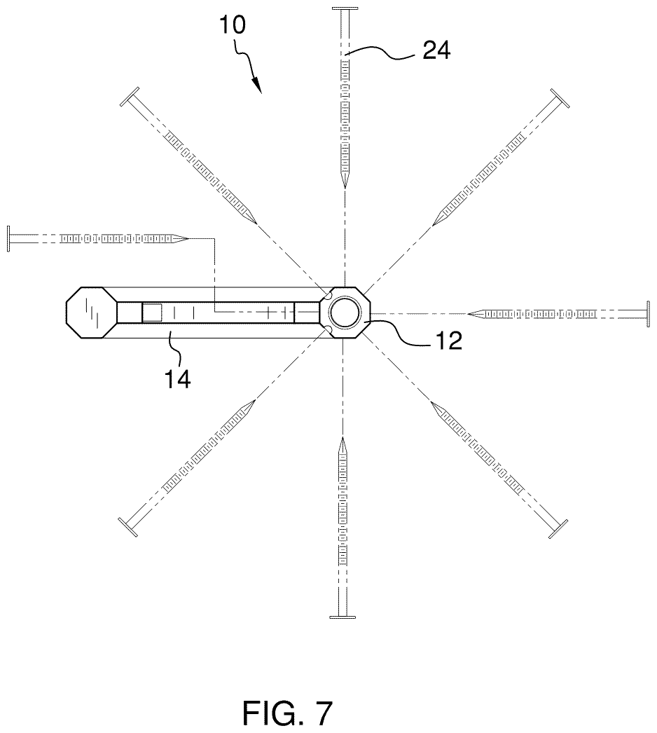

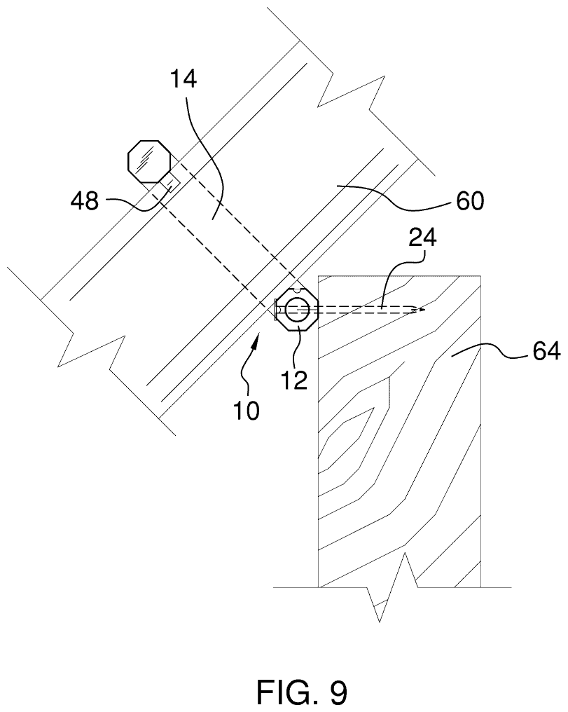

FIGS. 7 through 9 show the use of the J-hook 10. FIG. 7 shows the different positions or angles that the securing elements 24, in this case nails, could be inserted through the rod 12. These different insertion positions allow affixing of the J-hook 10 to a variety of building structures at different angles. FIG. 8 shows a traditional installation of the J-hook 10 to a joist 64 with the hook 14 projecting perpendicular to the surface of the joist 64. Two securing elements 24, specifically nails, are inserted through rod 12, with one securing element 24 through the main rod section 34 and the other securing element 24 through the extension rod section 36. A pipe 60 is located in the hook 14 with the elongated projection 28 helping to hold the pipe 60 in place. In contrast, FIG. 9 shows an unconventional positioning of the J-hook 10 that is only achievable by the octagonal shape of the rod 12. In this example, the rod 12 is positioned such that the hook 14 is projecting at a 45-degree angle with respect to the surface of the joist 64, even though the securing element 24 is still inserted perpendicular to the surface of the joist 64 as in FIG. 8. The pipe 60 can now be oriented in a position other than parallel and flat against the surface of the joist 64.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A J-hook for supporting a pipe comprising:
a rod having a first end and a second end, said rod including eight side surfaces such that said rod has an octagonal cross-sectional shape, said rod including a plurality of apertures in said side surfaces, said apertures being arranged in aligned pairs of opposing apertures to permit insertion of a securing element through a selectable one of said aligned pairs of opposing apertures such that the securing element extends through said rod perpendicular to an axis of said rod and into a building structure on which a pipe is to be mounted; and
a hook being disposed at said second end of said rod, said hook being U-shaped and defining a receptacle space being configured to receive a portion of the pipe therein in a contoured fit.

2. The J-hook of claim 1, further comprising an elongated projection being disposed to project inwardly from a surface of said hook into said receptacle space, said elongated projection being configured to project partially above an exposed upper surface of the portion of the pipe in said hook and be in contact with the exposed upper surface to block upward movement of the pipe out of said hook.

3. The J-hook of claim 2, wherein said elongated projection includes resilient material to permit temporary deformation of said elongated projection out of an initial position during insertion of the portion of the pipe into said hook and return to said initial position in a snap-fit manner.

4. The J-hook of claim 3, wherein said elongated projection is disposed at an upper portion of said hook, said elongated projection is a barb angled downwardly into said receptacle and includes a pointed tip.

5. The J-hook of claim 1, further comprising two slots being disposed in said side surfaces and extending parallel to the axis of said rod, each of said slots being configured to receive and store a securing element.

6. The J-hook of claim 1, wherein said hook includes a main hook section integrally formed with said rod and a detachable hook section detachably connected to said main hook section, said detachable hook section having a smaller width and depth than said main hook section to permit said hook to receive pipes of different diameters.

7. The J-hook of claim 6, wherein said detachable hook section includes said elongated projection, and said main hook section includes an additional elongated projection.

8. The J-hook of claim 1, wherein said rod includes measurement markings on one of said side surfaces.

9. The J-hook of claim 1, wherein said rod includes a main rod section integrally formed with said hook and an extension rod section connected to said main rod section, said extension rod section being detachable from said main rod section to permit shortening of said rod.

10. The J-hook of claim 9, wherein said main rod section includes a female threaded receptacle and said extension rod includes a male threaded projection configured to be screwed into said female threaded receptacle.

11. A J-hook for supporting a pipe comprising:
a rod having a first end and a second end, said rod including eight side surfaces such that said rod has an octagonal cross-sectional shape, said rod including a plurality of apertures in said side surfaces, said apertures being arranged in aligned pairs of opposing apertures to permit insertion of a securing element through a selectable one of said aligned pairs of opposing apertures such that the securing element extends through said rod perpendicular to an axis of said rod and into a building structure on which a pipe is to be mounted;
a hook being disposed at said second end of said rod, said hook being U-shaped and defining a receptacle space being configured to receive a portion of the pipe therein in a contoured fit;
an elongated projection being disposed to project inwardly from a surface of said hook into said receptacle space, said elongated projection being configured to project partially above an exposed upper surface of the portion of the pipe in said hook and be in contact with the exposed upper surface to block upward movement of the pipe out of said hook; and
two slots being disposed in said side surfaces and extending parallel to the axis of said rod, each of said slots being configured to receive and store a securing element.

12. The J-hook of claim 11, wherein:
said elongated projection includes resilient material to permit temporary deformation of said elongated projection out of an initial position during insertion of the portion of the pipe into said hook and return to said initial position in a snap-fit manner;
said elongated projection is disposed at an upper portion of said hook, said elongated projection is a barb angled downwardly into said receptacle and includes a pointed tip;
said hook includes a main hook section integrally formed with said rod and a detachable hook section detachably connected to said main hook section, said detachable hook section having a smaller width and depth than said main hook section to permit said hook to receive pipes of different diameters;
said detachable hook section includes said elongated projection, and said main hook section includes an additional elongated projection;
said rod includes measurement markings on one of said side surfaces;
said rod includes a main rod section integrally formed with said hook and an extension rod section connected to said main rod section, said extension rod section being detachable from said main rod section to permit shortening of said rod; and
said main rod section includes a female threaded receptacle and said extension rod includes a male threaded projection configured to be screwed into said female threaded receptacle.
